(19) United States
(12) Patent Application Publication
(10) Pub. No.: US 2025/0158423 A1
(43) Pub. Date: May 15, 2025

(54) BATTERY SYSTEM

(71) Applicant: TOYOTA JIDOSHA KABUSHIKI KAISHA, Toyota-shi (JP)

(72) Inventors: Yohei OGAWA, Nagoya-shi (JP); Hiroshi YOSHIDA, Anjo-shi (JP); Takashi OGURA, Seto-shi (JP); Yuki SUGO, Seto-shi (JP)

(73) Assignee: TOYOTA JIDOSHA KABUSHIKI KAISHA, Toyota-shi (JP)

(21) Appl. No.: 18/822,847

(22) Filed: Sep. 3, 2024

(30) Foreign Application Priority Data
Nov. 13, 2023 (JP) 2023-192984

(51) Int. Cl. H02J 7/00

(52) U.S. Cl. CPC H02J 7/0014; H02J 7/0047

(57) ABSTRACT

The battery system is a system for equalizing the capacity of each cell included in a battery in which a plurality of cells having a plateau region in a charge-discharge curve are connected in series, and includes an equalization unit for adjusting the capacity of each cell, and an ECU for controlling the charge-discharge of the battery. ECU determines which control method is used according to a predetermined determination condition for determining which of the first control method and the second control method is suitable for equalization in the present situation, and controls the equalization unit.

### CROSS-REFERENCE TO RELATED APPLICATION

This application claims priority to Japanese Patent Application No. 2023-192984 filed on Nov. 13, 2023, incorporated herein by reference in its entirety.

### BACKGROUND

### 1. Technical Field

The present disclosure relates to battery systems, and more particularly. to a battery system that equalizes the capacities of battery cells included in a battery pack in which a plurality of battery cells having a plateau region in a charge-discharge curve is connected in series.

### 2. Description of Related Art

Conventionally, there has been a technique for equalizing the voltage differences between cells based on state of charge-open circuit voltage (SOC-OCV) characteristics specific to LFP (Li, Fe, P: lithium iron phosphate) batteries (see, for example, Japanese Unexamined Patent Application Publication No. 2019-92276 (JP 2019-92276 A)). A plurality of cells is connected in series in a battery pack of an LFP battery, and in this technique, the voltage differences between the cells are equalized according to the differences between the times required for the voltages of the cells to pass between measurement points Pa, Pb at two voltage steps on an SOC-OCV curve.

### SUMMARY

However, if the voltages of the cells do not pass through the measurement points Pa, Pb, the opportunity to perform equalization to improve the estimation accuracy of the internal state of the cells cannot be secured.

The present disclosure provides a battery system that can secure an opportunity for equalization.

A battery system that equalizes capacities of a plurality of battery cells included in a battery pack, the battery cells having a plateau region in a charge-discharge curve and being connected in series in the battery pack.

The system includes:
an adjusting unit configured to adjust capacities of the battery cells; and
a control device configured to control charging and discharging of the battery pack.
The control device is configured to: determine whether to use a first control method or a second control method according to a predetermined determination condition for determining which of the first control method and the second control method is suitable for equalization in a current situation;
when determination is made that the first control method is to be used, control the adjusting unit to equalize the capacities of the battery cells by the first control method; and
when determination is made that the second control method is to be used, control the adjusting unit to equalize the capacities of the battery cells by the second control method.

With such a configuration, it is possible to equalize the capacities of the battery cells included in the battery pack by using the control method suitable for the current situation. As a result, it is possible to provide a battery system that can secure an opportunity for equalization.

The battery system may further include a sensor configured to detect a voltage of each of the battery cells included in the battery pack.

The first control method may be a control method using an open circuit voltage that is the voltage of each of the battery cells detected by the sensor when power is not output from the battery pack to outside.
The second control method may be a control method using a closed circuit voltage that is the voltage of each of the battery cells detected by the sensor when the power is output from the battery pack to the outside.

With such a configuration, the equalization can be performed by either the control method using the open circuit voltage or the control method using the closed circuit voltage, whichever is suitable for the equalization in the current situation.

The determination condition may be a condition that, when the current situation is a predetermined situation, the second control method is preferentially used over the first control method, and when the current situation is not the predetermined situation, the first control method is preferentially used over the second control method, the predetermined situation being a situation in which priority is given to securing an opportunity for the equalization over ensuring accuracy of the equalization.

With such a configuration, it is possible to perform the equalization by preferentially using either the first control method suitable for ensuring accuracy of the equalization or the second control method suitable for securing an opportunity for the equalization, according to whether the current situation is a situation in which priority is given to ensuring accuracy of the equalization or a situation in which priority is given to securing an opportunity for the equalization.

The predetermined situation may be a situation in which a predetermined period of time has elapsed since last equalization. With such a configuration, when the predetermined period of time has elapsed since the last equalization, priority is given to securing an opportunity for the equalization, and the equalization can be performed by preferentially using the second control method suitable for securing an opportunity for the equalization. On the other hand, when the predetermined period of time has not elapsed since the last equalization, priority is given to ensuring accuracy of the equalization, and the equalization can be performed by preferentially using the first control method suitable for ensuring accuracy of the equalization.

The predetermined situation may be a situation in which a difference between the capacities of the battery cells is equal to or greater than a predetermined threshold. With such a configuration, when the difference between the capacities of the battery cells is equal to or greater than the predetermined threshold, priority is given to securing an opportunity for the equalization, and the equalization can be performed by preferentially using the second control method suitable for securing an opportunity for the equalization. On the other hand, when the difference between the capacities of the battery cells is less than the predetermined threshold, priority is given to ensuring accuracy of the equalization, and the equalization can be performed by preferentially using the first control method suitable for ensuring accuracy of the equalization.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an entire configuration diagram of an electrified vehicle in which a battery system according to this embodiment is mounted;

FIG. 2 is a diagram illustrating an example of an equalization unit;

FIG. 3 is a flowchart illustrating a flow of equalization control processing in the first embodiment;

FIG. 4 shows SOC-OCV profile of a cell;

FIG. 5 is a flow chart showing a flow of the equalization control process according to the second embodiment; and

FIG. 6 is a flowchart illustrating a flow of equalization control processing according to a modification.

### DETAILED DESCRIPTION OF EMBODIMENTS

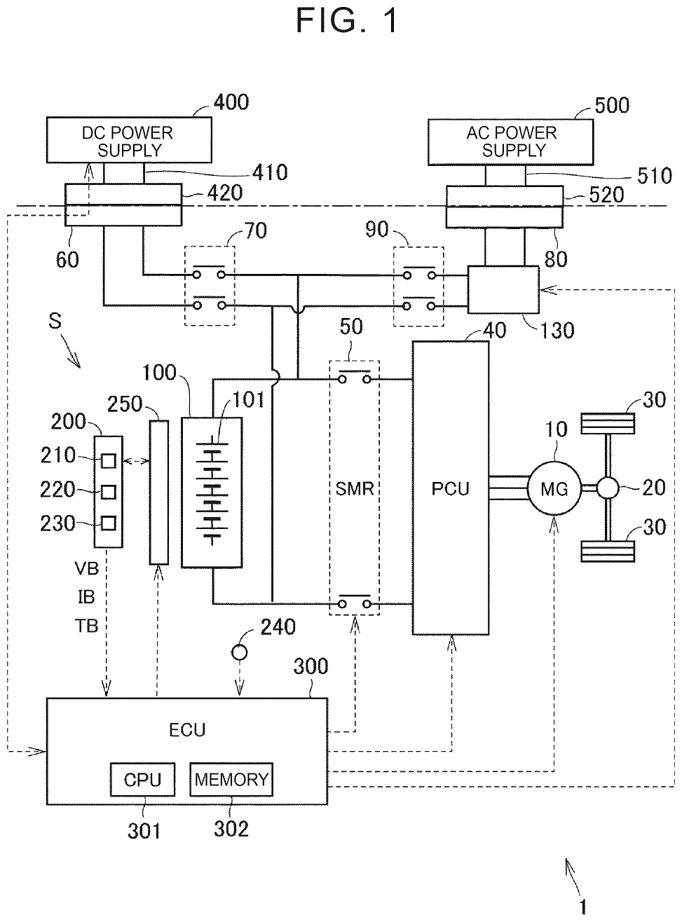

FIG. 1 is an entire configuration diagram of an electrified vehicle 1 in which a battery system S according to this embodiment is mounted. In this embodiment, electrified vehicle 1 is, for example, battery electric vehicle. Electrified vehicle 1 includes a motor generator (MG) 10, a power transmission gear 20, drive wheels 30, a power control unit (PCU) 40, a system main relay (SMR) 50, a battery 100, a monitoring unit 200, and an electronic control unit (ECU) 300. The electronic control unit is an example of a control device.

MG 10 is, for example, an embedded-structure permanent-magnet synchronous motor (IPM motor), and has a function as an electric motor (motor) and a function as a power generator (generator). The output-torque of MG 10 is transmitted to the drive wheels 30 via the power transmission gear 20 including a speed reducer, a differential, and the like.

When electrified vehicle 1 is braked, MG 10 is driven by the drive wheels 30, and MG 10 operates as a generator. As a result, MG 10 also functions as a braking device that performs regenerative braking for converting kinetic energy of electrified vehicle 1 into electric power. Regenerated electric power generated by regenerative braking force in the MG 10 is stored in the battery 100.

The PCU 40 is a power conversion device that bidirectionally converts electric power between the MG 10 and the battery 100. The PCU 40 includes an inverter and a converter that operate, for example, based on a control signal from the ECU 300.

When the battery 100 is discharged, the converter steps up voltage supplied from the battery 100 and supplies the stepped-up voltage to the inverter. The inverter converts DC power which is supplied from the converter into AC power and drives the MG 10.

On the other hand, when the battery 100 is charged, the inverter converts AC power generated by MG 10 into DC power and supplies the DC power to the converter. The converter steps down voltage supplied from the inverter to voltage suitable for charging the battery 100 and supplies the stepped-down voltage to the battery 100.

The SMR 50 is electrically connected to power lines connecting the battery 100 and the PCU 40. If SMR 50 is ON (i.e., conductive) in response to a control signal from ECU 300, power may be transferred between the battery 100 and PCU 40. On the other hand, when SMR 50 is OFF (i.e., disconnected) in response to a control signal from ECU 300, the battery 100 is disconnected from PCU 40.

The battery 100 stores electric power for driving MG 10. The battery 100 is a DC power source (secondary battery) that can be recharged, and is a battery pack in which a plurality (n) of cells (battery cells) 101 are stacked and electrically connected in series, for example. The cell 101 may be composed of, for example, a lithium-ion battery. In this embodiment, an iron phosphate lithium-ion battery (LFP battery) using lithium iron phosphate as a positive electrode active material is employed as the cell 101.

The monitoring unit 200 includes a voltage detection unit 210, a current sensor 220, and a temperature sensor 230. The voltage detection unit 210 detects the voltage VB of the cells 101 (the voltage VB between the terminals of the cells 101). The current sensor 220 detects a current IB input to and output from the battery 100 (cell 101). The temperature sensor 230 detects a temperature TB of each of the cells 101. The detection units output the results of this detection to the ECU 300.

Electrified vehicle 1 includes a DC inlet 60, and the battery 100 can be rapidly charged from an external direct current (DC) power supply that is a charging facility. DC inlet 60 is configured to be connectable to a connector 420 provided at a distal end of the charging cable 410 of the external DC power supply (charging facility) 400. The charge relay 70 is electrically connected to a power line connecting DC inlet 60 and the battery 100. The charge relay 70 switches between supplying and shutting off power between DC inlet 60 and the battery 100 in response to a control signal from ECU 300. When the charge relay 70 is closed, external charging (quick charging) of the battery 100 is performed.

Electrified vehicle 1 includes an AC inlet 80, and the battery 100 can be normally charged from an external alternating current (AC) power supply, which is a charging facility. AC inlet 80 is configured to be connectable to a connector 520 provided at a distal end of the charging cable 510 of the external AC power supply (charging facility) 500. An in-vehicle charger 130 is provided in a power line between AC inlet 80 and the battery 100, and converts AC power supplied from an external AC power source into DC power and converts the battery 100 into a chargeable voltage. The charge relay 90 is electrically connected to a power line connecting the in-vehicle charger 130 and the battery 100. The charge relay 90 switches between supplying and shutting off the electric power between the in-vehicle charger 130 and the battery 100 in response to a control signal from ECU 300. When the charge relay 90 is closed, external charging (normal) of the battery 100 is performed.

The ECU 300 includes a central processing unit (CPU) 301, and a memory (including, for example, a read only memory (ROM) and a random access memory (RAM)) 302. ECU 300 controls the respective devices so that electrified vehicle 1 is in a desired condition based on a signal received from the monitoring unit 200, a signal (for example, an accelerator operation amount signal, a vehicle speed signal, and the like) from various sensors (not shown), a map and a program stored in the memory 302, and the like. In addition, ECU 300 performs the equalization process of the cells 101 using the equalization unit (equalization circuitry) 250. The battery system S includes a battery 100 (cell 101), a monitoring unit 200, an equalization unit 250, an ECU 300, and the like.

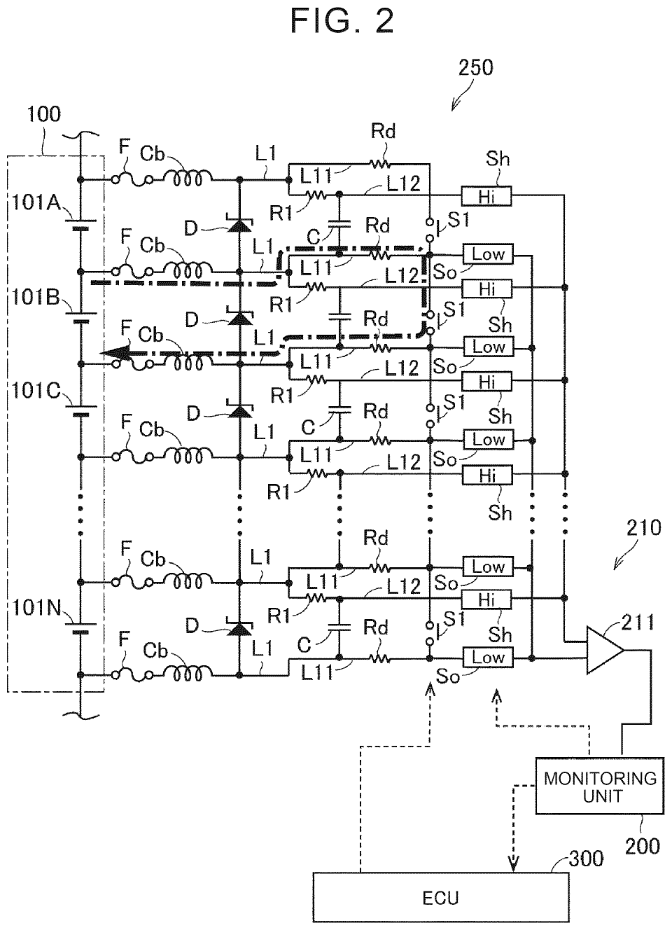

FIG. 2 is a diagram illustrating an example of the equalization unit 250. In this embodiment, the equalization unit 250 is incorporated as an equalization circuit in the voltage detection unit (voltage detection circuit) 210 of the monitoring unit 200. In the battery 100, a plurality (n) of cells (battery cells) 101A to 101N (typically referred to as “cells 101”) are connected in series. The voltage detection unit 210 detects the voltages of the cells 101A to 101N via the plurality of voltage detection lines L1, the branch lines L11, and the branch lines L12. The first voltage detection line L1 is connected to the positive terminal of the cell 101A. The second to (n+1)th voltage detection lines L1 are connected to the negative electrode terminal of one cell and the positive electrode terminal of the other cell between neighboring cells of the cells 101A to 101N.

A fuse F and a chip-bead Cb are provided in the voltage detection line L1. The fuse F is blown when an overcurrent occurs to protect the circuit. The chip-bead Ch reduces the applied stress when the surge-voltage is applied instantaneously.

A Zener diode D is connected in parallel to each of the cells 101A to 101N via a neighboring voltage detection line L1. The cathode of the Zener diode D is connected to the positive terminal side of the corresponding cell, and the anode is connected to the negative terminal side of the corresponding cell. When an overvoltage is applied from the battery 100 (cell 101) to the voltage detection unit 210, a current flows through the Zener diode D to protect the voltage detection unit 210 from the overvoltage.

The voltage detection line L1 branches from the Zener diode D to the branch line L11 and the branch line L12 at the monitoring unit 200. The branch line L11 is connected to the comparator 211 via the switch So, and the branch line L12 is connected to the comparator 211 via the switch Sh. Switch So and switch Sh may use, for example, photo metal oxide semiconductor (MOS) relays. The branch line L11 branched from the voltage detection line L1 connected to the positive electrode terminal of the cell 101A disposed on the positive electrode output terminal of the battery 100 is not connected to the comparator 211. In addition, the voltage detection line L1 connected to the negative electrode terminal of the cell 101N disposed on the negative electrode-output terminal of the battery 100 does not include the branch line L12.

A resistor R1 is provided in the branch line L12. A capacitor (flying capacitor) C is provided between the branch line L12 connected to the positive electrode terminal of each cell and the branch line L11 connected to the negative electrode terminal. In the branch line L12, the capacitor C is connected between the resistor R1 and the switch Sh, and forms a RC low-pass filter by the resistor R1 and the capacitor C. Each of the capacitors C is connected in parallel with the corresponding cells 101A to 101N. The charge of the corresponding cells 101A to 101N is charged to the capacitor C, and the voltage value of the capacitor C becomes equal to the voltage value of the corresponding cells 101A to 101N. The comparator 211 outputs the voltage (cell voltage) VB of the specific cells 101A to 101N by turning ON (closing) the switch Sh and the switch So corresponding to the specific cells 101A to 101N. Thus, the monitoring unit 200 can use the voltage detection unit 210 to detect the voltage VB of each of the cells 101A to 101N by sequentially turning on switch Sh and switch So corresponding to each of the cells 101A to 101N. Further, the voltage Vb of the battery 100 can be detected by turning ON (closing) the switch Sh of the cell 101A and the switch So connected to the negative electrode terminal of the cell 101N.

The equalization unit 250 includes a discharging resistor Rd provided in the branch line L11 and a switching S1 that conducts (closes)/disconnects (opens) between neighboring branch lines L11. The switching S1 is switched between ON (closed) and OFF (open) by receiving a control signal from ECU 300. In FIG. 2, arrows indicated by dashed-dotted lines indicate current flows when the equalization control is executed in order to eliminate unevenness in SOC of the cell 101. It is shown that the cell 101B has a large SOC, discharging is performed from the cell 101B, and the equalization control is executed. When the cell 101B has a large SOC, the switching S1 corresponding to the cell 101B is turned ON (closed). When the switching S1 corresponding to the cell 101B is turned ON (closed), the current discharged from the cell 101B is consumed by the two discharging resistors Rd, and SOC of the cell 101B decreases, as indicated by a dashed-dotted arrow, and the equalization of SOC is performed. In this way, equalization between the cells 101 of the battery 100 (battery pack) is performed.

Conventionally, there has been a technique in which, based on SOC-OCV properties peculiar to a LFP cell, the voltage of each cell of a battery pack in which a plurality of cells of a LFP cell are connected in series is equalized in accordance with a time difference required to pass between measurement points Pa, Pb of two voltage steps on a SOC-OCV curve. However, if the cell does not pass through the measurement points Pa, Pb, the equalization for improving the estimation accuracy of the inner condition of the cell cannot be performed.

Therefore, ECU 300 determines which of the first control method and the second control method is suitable for equalization in the current situation according to a predetermined determination condition. When it is determined that the first control method is used, ECU 300 controls the equalization unit 250 so as to equalize the capacitance of each of the cells 101 using the first control method. When it is determined that the second control method is used, ECU 300 controls the equalization unit 250 so as to equalize the capacitance of each of the cells 101 using the second control method. As a result, it is possible to equalize the capacity of the cells 101 included in the battery 100 using a control method suitable for the current situation. As a result, an opportunity for equalization can be secured.

### First Embodiment

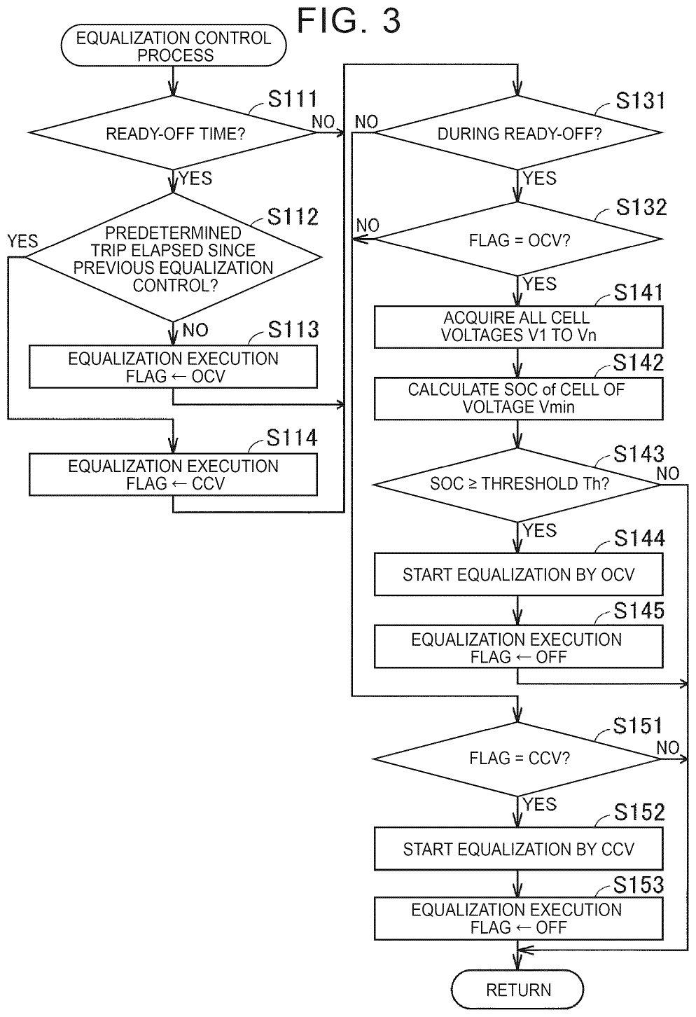

FIG. 3 is a flowchart illustrating a flow of equalization control processing in the first embodiment. Referring to FIG. 3, the equalization control process is periodically called and executed by CPU 301 of ECU 300 from the higher-level process. CPU 301 determines whether or not electrified vehicle 1 power switch is at Ready-OFF immediately after being turned Ready-OFF by the user's manipulation (S111). If it is determined that the time is Ready-OFF time (YES in S111), CPU 301 determines whether or not a predetermined trip (for example, 10 trips) has elapsed since the previous execution of the equalization control (S112). The trip refers to a single trip from when electrified vehicle 1 is operated to make a Ready-ON to when it is operated to make a Ready-OFF.

When it is determined that the predetermined trip has not elapsed since the execution of the previous equalization control (NO in S112), CPU 301 stores, as the equalization execution flag, a flag indicating that the equalization by OCV is to be executed in the memory 302 (S113). The equalization by OCV refers to the equalization control of SOC of each of the cells 101A to 101N included in the battery 100 using OCV. On the other hand, when it is determined that a predetermined trip has elapsed (YES in S112) since the execution of the previous equalization control, CPU 301 stores a flag indicating that the equalization by CCV (closed circuit voltage) is executed as the equalization execution flag in the memory 302 (S114). The equalization by CCV refers to the equalization control of SOC of the cells 101A to 101N included in the battery 100 using CCV.

After S113 or S114, CPU 301 determines whether it is during Ready-OFF (e.g., during Ready-OFF after external charging is complete, during Ready-OFF when external charging is not performed) (S131). If it is determined that Ready-OFF is in progress (YES in S131), CPU 301 determines whether or not the equalization execution flag stored in the memory 302 is a flag indicating that the equalization by OCV is executed (S132). When it is determined that the flag indicates that the equalization by OCV is to be executed (YES in S132), CPU 301 acquires the open circuit voltage V1 to Vn of all the cells 101A to 101N included in the battery 100 (S141). In the circuitry shown in FIGS. 1 and 2, even when SMR 50 and the charge relays 70 and 90 are opened, a current flows through the monitoring unit 200 when the voltage of each of the cells 101A to 101N is measured. Therefore, the voltage of each of the cells 101A to 101N detected in this state is not strictly OCV, but is treated as OCV.

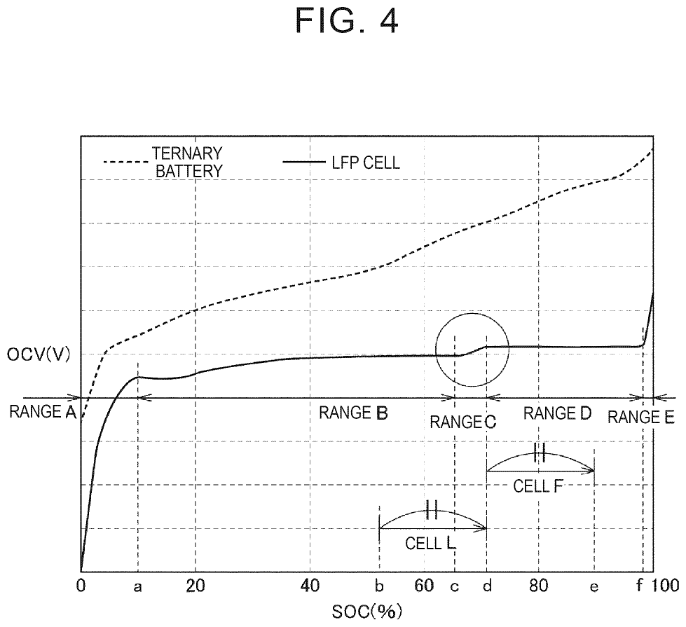

FIG. 4 is a diagram illustrating a SOC-OCV diagram of a cell. Referring to FIG. 4, the vertical axis of the graph represents OCV (unit: V), and the horizontal axis represents SOC (unit: %). The solid line plots SOC-OCV of the cell 101 of the LFP battery used in this embodiment. The dashed lines show SOC-OCV curves of conventional ternary cell cells.

Returning to FIG. 3, CPU 301 calculates SOC of the cell of the lowest voltage Vmin among the cells 101A to 101N included in the battery 100 using SOC-OCV curve shown in FIG. 4 (S142). CPU 301 determines whether or not the calculated SOC is equal to or greater than a threshold Th.

Referring back to FIG. 4, SOC-OCV curve of the disclosed cell 101 includes a range A in the range of SOC=0 to a, a range B in the range of SOC=a to c, a range C in the range of SOC=c to d, a range D in the range of SOC=d to f, and a range E in the range of SOC=f to 100. In the range A, OCV increases rapidly with increasing SOC. In the range B, OCV increase with increasing SOC is slow. In the range C, there is a “step” in the increase of OCV with the increase of SOC. Even in a case where the cell 101 is deteriorated and the full charge capacity of the cell 101 is reduced (a case where the capacity retention rate of the cell 101 is reduced), the position of the “step” is not changed. Even if the cell 101 deteriorates, the value of the remaining capacity in which the “step” appears does not change. In the range D, there is almost no increase in OCV with increasing SOC. This range D is referred to as a plateau region. Range B may also be referred to as the plateau region. In the range E, OCV increases rapidly with increasing SOC. It should be noted that OCV of SOC-OCV curve of the conventional ternary cell increases proportionally over almost the entire area as SOC increases.

In the range B to the range D, the change in OCV with respect to the change in SOC is smaller than in the range A and the range E. Therefore, in the range B to the range D, it is difficult to equalize by OCV. Therefore, in the range E, that is, in the range where SOC is equal to or larger than f, the equalization by OCV is performed. Therefore, S143 thresholds Th=f.

Returning to FIG. 3, if it is determined that SOC is equal to or larger than the threshold Th (YES in S143), CPU 301 starts equalization by OCV (S144). The equalization by OCV is specifically performed as follows. With SMR 50 and the charge relays 70 and 90 open, the monitoring unit 200 measures OCV of the individual cells 101. Based on OCV, SOC of the individual cells 101 are calculated using SOC-OCV curve. For a cell 101 having a SOC in which the difference with respect to the smallest SOC is equal to or larger than a predetermined value, the corresponding switching S1 is turned ON (closed) for a period corresponding to the difference. As a result, electric power corresponding to differences is consumed by the discharging resistor Rd. Consequently, SOC of the cells 101 decreases according to the difference, and the equalization of SOC is performed.

After S144, CPU 301 stores a flag indicating that the equalization is turned off as the equalization execution flag in the memory 302 (S145). If it is determined that SOC is less than the threshold Th (NO in S143), or after S145, CPU 301 returns the processing to be executed to the processing of the upper level of the caller of the equalization control processing.

If it is determined that the vehicle is not in Ready-OFF (NO in S131), for example, is running or stopped in Ready-ON, or if it is determined that the equalization execution flag is not a flag indicating that the equalization by OCV is to be executed (NO in S132), CPU 301 determines whether the equalization execution flag stored in the memory 302 is a flag indicating that the equalization by CCV is to be executed (S151). When it is determined that the flag indicates that the equalization by CCV is to be performed (YES in S151), CPU 301 starts the equalization by CCV (S152). Thus, equalization by CCV may be performed not only during Ready-OFF, but also during Ready-OFF, as indicated in the process flow of S131 and S132.

Referring back to FIG. 4, equalization by CCV is specifically performed as follows. The monitoring unit 200 measures CCV of the individual cells 101 in a state in which SMR 50 is closed (Ready-ON state) or in a state in which any one of the charge relays 70 and 90 is closed (a state in which external charge is executed). Based on CCV, a tentative SOC of the individual cells 101 is calculated using SOC-OCV curve.

When Ready-ON is in progress and regeneration from MG 10 to the battery 100 is being performed, or when Ready-OFF is being performed and the battery 100 is being externally charged, SOC of the individual cells 101 is increased. In this case, among the cells 101A to 101N included in the battery 100, SOC difference for the cell L, which is the cell 101 exceeding the “level difference” of SOC=c to d, is calculated for the cell F, which is the cell 101 exceeding the “level difference” of the first SOC=c to d, and finally exceeding the “level difference” of SOC=c to d. Specifically, if SOC of the cell L when the cell F exceeds the “step” is b and SOC of the cell F when the cell L exceeds the “step” is e, it is possible to calculate SOC difference=e−d≈d−b. SOC differences of the cells exceeding the “step” between the cell F and the cell L with respect to the cell L are also calculated in the same manner. For the cells 101 in SOC where SOC difference is equal to or greater than the predetermined value, the corresponding switching S1 is turned ON (closed) for a time period corresponding to the difference. As a result, the regenerative power or the charging power is charged for all the cells 101A to 101N included in the battery 100, while the power corresponding to the difference is consumed by the discharging resistor Rd for the cells 101 having SOC of SOC difference equal to or larger than the predetermined value. As a consequence, SOC of the cells 101 having SOC difference equal to or greater than the predetermined value decreases according to the difference, and SOC equalization is performed.

When Ready-ON is in progress and power is being outputted from the battery 100 to MG 10, SOC of the individual cells 101 is reduced. In this case, among the cells 101A to 101N included in the battery 100, SOC difference for the cell L, which is the cell 101 exceeding the “level difference” of SOC=d to c, is calculated for the cell F, which is the cell 101 exceeding the “level difference” of SOC=d to c, at the end. SOC differences of the cells exceeding the “step” between the cell F and the cell L with respect to the cell L are also calculated in the same manner. For the cells 101 in SOC where SOC difference is equal to or greater than the predetermined value, the corresponding switching S1 is turned ON (closed) for a time period corresponding to the difference. As a result, the power outputted to MG 10 is consumed for all the cells 101A to 101N included in the battery 100. In addition, the electric power corresponding to the difference is further consumed by the discharging resistor Rd for the cell 101 having SOC of SOC difference equal to or larger than the predetermined value. As a consequence, SOC of the cells 101 having SOC difference equal to or greater than the predetermined value decreases according to the difference, and SOC equalization is performed.

Returning to FIG. 3, after S152, CPU 301 stores a flag indicating that the equalization is turned off as the equalization execution flag in the memory 302 (S153). When it is determined that the equalization execution flag is not a flag indicating that the equalization by CCV is to be executed (NO in S151), or after S153, CPU 301 returns the processing to be executed to the processing higher than the caller of the equalization control processing.

### Second Embodiment

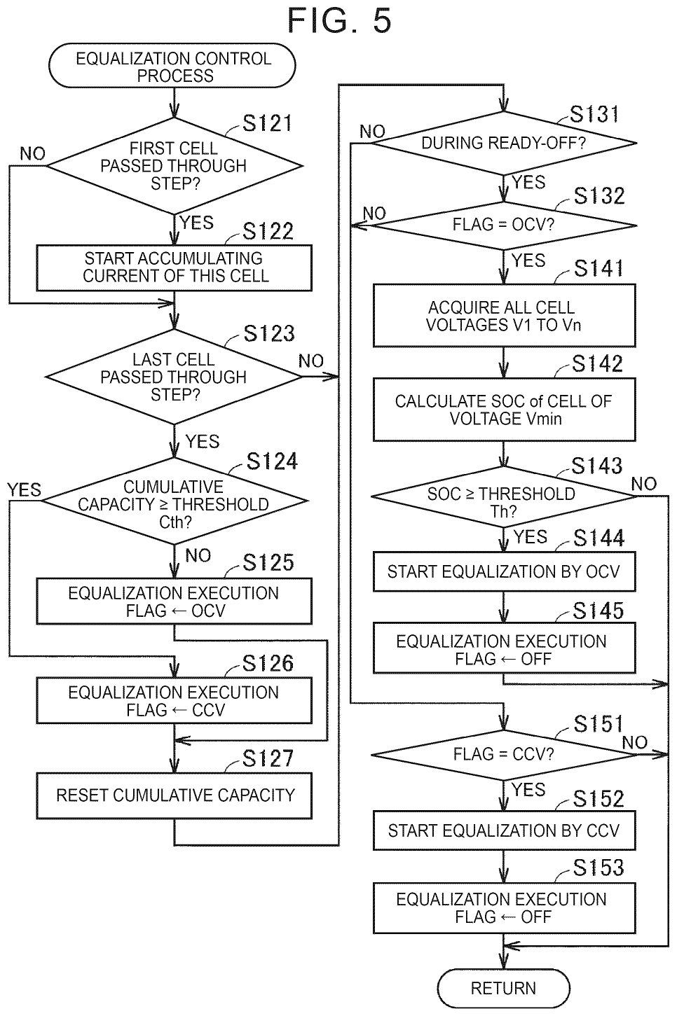

FIG. 5 is a flowchart illustrating a flow of equalization control processing in the second embodiment. Referring to FIG. 5, the equalization control process is periodically called and executed by CPU 301 of ECU 300 from the higher-level process. S131 to S153 are the same as the equalization control process according to the first embodiment described with reference to FIG. 3, and therefore will not be repeated. CPU 301 determines whether or not the first cell 101 has passed through the “step” (S121). When it is determined that it is the passed timing (YES in S121), CPU 301 starts current integration of the cell (S122).

If it is determined that the timing at which the first cell 101 passes through the “step” is not the timing (NO in S121), or after S122, CPU 301 determines whether or not the timing at which the last cell 101 passes through the “step” is the timing (S123). When it is determined that the current is the passing timing (YES in S123), CPU 301 determines whether or not the integrated capacity of the current that has started the integration in S122 is equal to or larger than the threshold Cth (for example, 5 Ah) (S124). When it is determined that the integrated capacitance is less than the threshold Cth (NO in S124), CPU 301 stores, as the equalization execution flag, a flag indicating that the equalization by OCV is executed in the memory 302 (S125). On the other hand, if it is determined that the integrated capacitance is equal to or larger than the threshold Cth (YES in S124), CPU 301 stores, as the equalization execution flag, a flag indicating that the equalization by CCV is to be executed in the memory 302 (S126). After S125 or S126, CPU 301 resets the integrated capacitance (S127). After S127, CPU 301 executes S131 and subsequent processes in the same manner as the equalization control process of the first embodiment described with reference to FIG. 3.

### Modifications

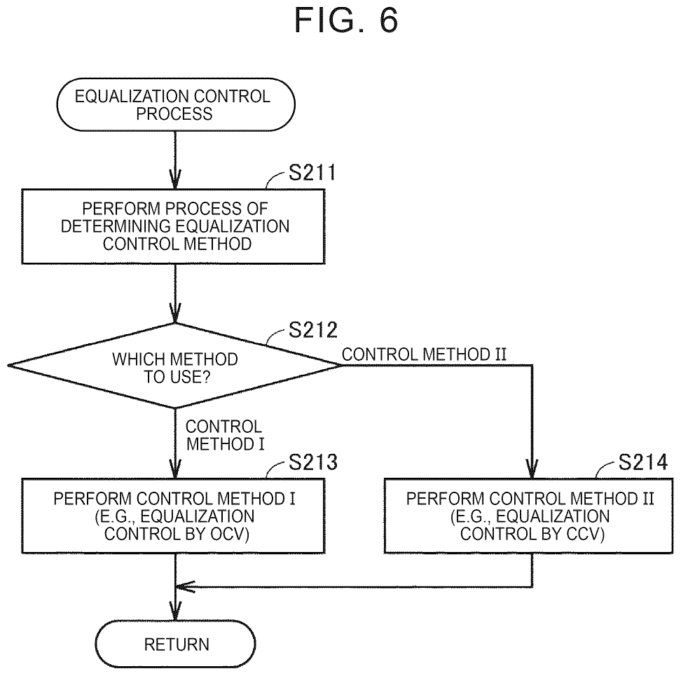

(1) As described in the first and second embodiments, equalization by OCV or equalization by CCV is preferentially performed according to the situation. However, the present disclosure is not limited thereto, and the equalization control process may be executed as described below. FIG. 6 is a flowchart illustrating a flow of equalization control processing according to a modification. Referring to FIG. 6, CPU 301 performs a process of determining a method of equalization control (S211). CPU 301 determines whether S211 is determined to be the control method I or the control method II (S212). If it is determined to be the control method I, CPU 301 executes the control method I (for example, equalization control by OCV) (S213). On the other hand, when it is determined that the control method is II, CPU 301 executes control method II (for example, equalization control by CCV) (S214).

In S211, it may be determined which control method is to be used depending on which equalization control method is suitable. For example, when the equalization opportunity is prioritized, it is determined that the control method is II suitable for securing the opportunity as compared with the control method I. When the accuracy of the equalization is prioritized, it is determined that the control method I is more suitable for securing the accuracy than the control method II. Other indicators may be used in addition to or instead of opportunity and accuracy.
(2) In the above-described embodiment, when it is determined that the equalization by OCV is suitable, the equalization by OCV is performed at a frequency of 100%, and when it is determined that the equalization by CCV is suitable, the equalization by CCV is performed at a frequency of 100%. However, the present disclosure is not limited thereto, and when it is determined that the equalization by OCV is suitable, the equalization by OCV may be performed preferentially over the equalization by CCV. When it is determined that the equalization by CCV is suitable, the equalization by CCV may be performed in preference to the equalization by OCV. For example, if it is determined that equalization by OCV is suitable, equalization by OCV may be performed more frequently than equalization by CCV. When it is determined that the equalization by CCV is suitable, the equalization by CCV may be performed more frequently than the equalization by OCV.

### SUMMARY

(1) As illustrated in FIGS. 1 and 2, the battery system S is a system that equalizes the capacitances of the cells 101 included in the battery 100 in which a plurality of cells 101A to 101N having plateau regions are connected in series in the charge-discharge curve. The battery system S includes an equalization unit 250 that adjusts the capacity of each of the cells 101, and an ECU 300 that controls charging and discharging of the battery 100. As illustrated in FIGS. 3 to 6, ECU 300 determines which control method is used according to a predetermined determination condition for determining which of the first control method (for example, equalization by OCV) and the second control method (for example, equalization by CCV) is suitable for equalization in the present situation. When it is determined that the first control method is used, ECU 300 controls the equalization unit 250 so as to equalize the capacitance of each of the cells 101 using the first control method. When it is determined that the second control method is used, ECU 300 controls the equalization unit 250 so as to equalize the capacitance of each of the cells 101 using the second control method.

As a result, it is possible to equalize the capacity of the cells 101 included in the battery 100 using a control method suitable for the current situation. As a result, an opportunity for equalization can be secured.
(2) As illustrated in FIGS. 3 to 6, a monitoring unit 200 for detecting the voltage of each cell 101 included in the battery 100 may be further provided. The first control method may be a control method using OCV which is a voltage of the cell 101 detected by the monitoring unit 200 when power is not outputted from the battery 100 to the outside. The second control method may be a control method using a CCV which is a voltage of the cell 101 detected by the monitoring unit 200 when power is outputted from the battery 100 to the outside.

Accordingly, the equalization can be performed using a control method suitable for equalization in the present situation among any of the control methods using OCV and CCV.
(3) As illustrated in FIGS. 3 to 6, the determination condition may be a condition in which, in a case where the current situation is a predetermined situation in which priority is given to securing an opportunity as compared with securing accuracy of equalization, the second control method is preferentially used as compared with the first control method, and in a case where the current situation is not a predetermined situation, the first control method is preferentially used as compared with the second control method. Preferential use of the second control method may be performed using only the second control method, or may be performed using the second control method more frequently than the first control method. Preferential use of the first control method may be performed using only the first control method, or the first control method may be used more frequently than the second control method.

As a result, it is possible to execute the equalization by giving priority to any one of the first control method suitable for securing the accuracy and the second control method suitable for securing the opportunity depending on whether the current situation is a situation in which the accuracy of equalization or the opportunity securing is prioritized.
(4) As illustrated in FIG. 3, the predetermined situation may be a situation in which a predetermined period of time has elapsed since the previous equalization. The predetermined period may be, for example, a period up to a predetermined number of trips, a traveling period of the vehicle, or a period up to a predetermined number of power-on times when the vehicle is not limited to being mounted on the vehicle, or a battery use period. As a result, when a predetermined period has elapsed since the previous equalization, the equalization can be performed by giving priority to the second control method suitable for securing the opportunity with priority given to securing the opportunity. When a predetermined period of time has not elapsed since the previous equalization, the equalization can be performed by giving priority to the first control method suitable for securing the accuracy by giving priority to securing the accuracy.
(5) As illustrated in FIG. 5, the predetermined situation may be a situation in which the capacity difference between the cells 101 is equal to or greater than a predetermined threshold value. Accordingly, when the capacity difference between the cells 101 is equal to or larger than the predetermined threshold value, the equalization can be performed by giving priority to the second control method suitable for securing the opportunity with priority given to securing the opportunity. When the capacity difference between the cells 101 is not equal to or larger than the predetermined threshold value, the equalization can be performed by giving priority to the first control method suitable for securing the accuracy while giving priority to securing the accuracy.

The embodiment disclosed herein shall be construed as exemplary and not restrictive in all respects. It is intended that the scope of the disclosure be defined by the appended claims rather than the description of the embodiments described above, and that all changes within the meaning and range of equivalency of the claims be embraced therein.

What is claimed is:

1. A battery system that equalizes capacities of a plurality of battery cells included in a battery pack, the battery cells having a plateau region in a charge-discharge curve and being connected in series in the battery pack, the battery system comprising:
an adjusting unit configured to adjust capacities of the battery cells; and
a control device configured to control charging and discharging of the battery pack, wherein the control device is configured to
determine whether to use a first control method or a second control method according to a predetermined determination condition for determining which of the first control method and the second control method is suitable for equalization in a current situation,
when determination is made that the first control method is to be used, control the adjusting unit to equalize the capacities of the battery cells by the first control method, and
when determination is made that the second control method is to be used, control the adjusting unit to equalize the capacities of the battery cells by the second control method.

2. The battery system according to claim 1, further comprising a sensor configured to detect a voltage of each of the battery cells included in the battery pack, wherein:
the first control method is a control method using an open circuit voltage that is the voltage of each of the battery cells detected by the sensor when power is not output from the battery pack to outside; and
the second control method is a control method using a closed circuit voltage that is the voltage of each of the battery cells detected by the sensor when the power is output from the battery pack to the outside.

3. The battery system according to claim 2, wherein the determination condition is a condition that, when the current situation is a predetermined situation, the second control method is preferentially used over the first control method, and when the current situation is not the predetermined situation, the first control method is preferentially used over the second control method, the predetermined situation being a situation in which priority is given to securing an opportunity for equalization over ensuring accuracy of the equalization.

4. The battery system according to claim 3, wherein the predetermined situation is a situation in which a predetermined period of time has elapsed since last equalization.

5. The battery system according to claim 3, wherein the predetermined situation is a situation in which a difference between the capacities of the battery cells is equal to or greater than a predetermined threshold.
